(19) United States
(12) Patent Application Publication
(10) Pub. No.: US 2006/0030360 A1
(43) Pub. Date: Feb. 9, 2006

(54) Earphone type music broadcaster

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/910,276

(22) Filed: Aug. 4, 2004

(51) Int. Cl. H04B 1/38

(52) U.S. Cl. 455/557

(57) ABSTRACT

An earphone type music broadcaster is provided, wherein an earphone type main body comprises an audio signal input unit; an audio signal processing control unit; a wireless transmission apparatus used; an auto-switch; and a sound output unit. The earphone type music broadcaster is hanged directly on the ear by using the earphone type main body for listening to the MP3 music. The wireless transmission apparatus is used for receiving the wireless telecommunication signal to enable the music broadcaster to take the phone call automatically. When a phone call is incoming, the auto-switch can be used to take the phone call. When the communication is terminated, it can be switched back to the broadcasting of the music.

### BACKGROUND OF THE INVENTION

The present invention relates to an earphone type music broadcaster, and more particularly to a music broadcaster that is capable of directly hanging on the ear for listening to the music and taking a phone call.

The current MP3 Walkmans, each of which has almost the same functions, such as listening to MP3 music, portable hard disk for data storage, or sound-recording, are increasingly popular. The external form of which is not beyond the scope of having a portable type main body, wherein an earphone, by which the music is listened to, is inserted into the main body. Therefore, the music Walkman must be taken along with both the broadcaster and the earphone. It is a troublesome matter and very inconvenient. Moreover, the mobile phone has been become a requirement of life at present. Almost every person is provided with one mobile phone. The probability of taking the phone call is very high. Accordingly, if a phone call is incoming during the listening to the music, the earphone must be taken off first in order to take the phone call. When the communication is finished, the mobile phone is then settled followed by wearing the earphone again to continue to listen to the music. It is very inconvenient while using. Furthermore, when the earphone is worn to listen to the music, it will be difficult to hear the ringing of the phone call since the ear is isolated from the external sound by the music, thus it is failed to take the phone call. It is indeed a problem waited for a resolution.

### SUMMARY OF THE INVENTION

The main purpose of the present invention is to provide an earphone type music broadcaster, which is in the form of an earphone type, to directly hang on the ear for listening to the music and to promote the convenience of using.

Another purpose of the present invention is to provide an earphone type music broadcaster, which comprises a wireless transmission apparatus to receive and transmit the wireless telecommunication signal to enable the music broadcaster to switch automatically to take a phone call.

According to the aforementioned purpose of the present invention, there is provided with an earphone type main body, which comprises a hook for hanging the main body on the ear. The main body comprises an audio signal input unit for inputting an external audio signal; an audio signal processing control unit for connecting with the audio signal input unit to process the signal of voice or music for sound-recording or broadcasting the music; a wireless transmission apparatus for signal transmission between the main body and the wireless phone to enable the main body to take the incoming phone call; an auto-switch connected to the audio signal processing unit and the wireless transmission apparatus for automatically controlling the broadcasting of the music or switching to taking of the incoming phone call; a sound output unit for broadcasting the music or the telecommunication signal by control of the auto-switch.

In the manner described above, the hook of the earphone type main body can be put directly on the ear to listen to the music without carrying an additional music broadcaster. When a phone call is incoming, the wireless transmission apparatus can be used to transmit the signal between the main body and the wireless phone to take the incoming phone call by using the auto-switch. When the communication is terminated, it is automatically switched back to the broadcasting of the music. It can be switched automatically for taking the phone call during the listening to the music. Therefore, it is able to promote the convenience of using without missing any phone call.

The aforementioned aspects and advantages of the present invention will be readily clarified in the hereafter description of examples of preferred embodiments of the present invention, in reference with the enclosed drawings.

The present invention intends to cover all alternatives and arrangements of these alternatives. Nevertheless, the selected preferred embodiment is described in the specification and illustrated in the accompanying drawings.

### BRIEF DESCRIPTION OF THE DRAWINGS

FIG. 1 is perspective diagram showing an outward-appearance diagram of the present invention.

FIG. 2 is schematic diagram of a speaker in accordance with another preferred embodiment of the present invention.

FIG. 3 is schematic, block diagram showing the constitution of the present invention.

FIG. 4 is a block diagram showing an audio signal processing control unit of the present invention.

FIG. 5 is a schematic, block diagram showing a bluetooth communication apparatus of the present invention.

FIG. 6 is a schematic diagram showing the usage status of the present invention.

FIG. 7 is a schematic diagram showing another usage status of the present invention.

FIG. 8 is diagram showing another preferred embodiment of the preferred embodiment.

### DETAILED DESCRIPTION OF THE PREFERRED EMBODIMENT

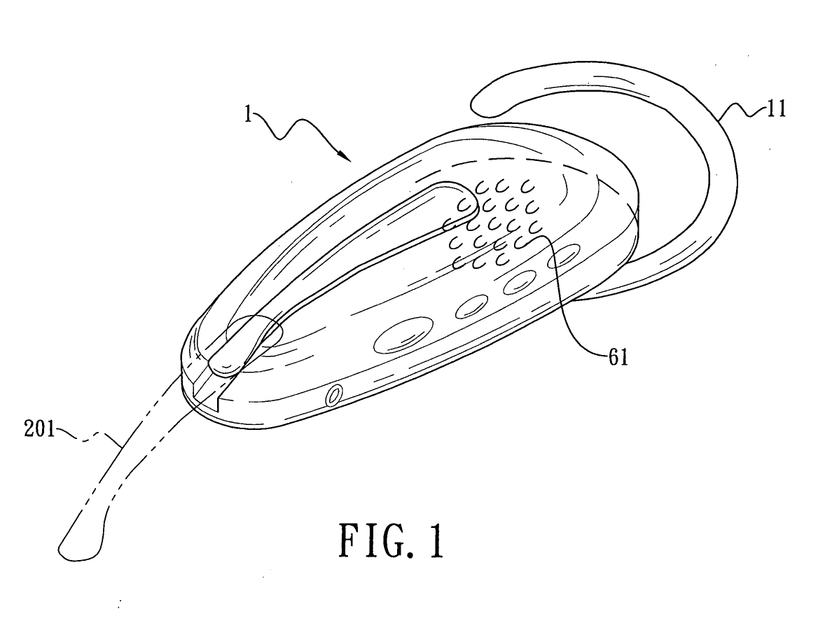

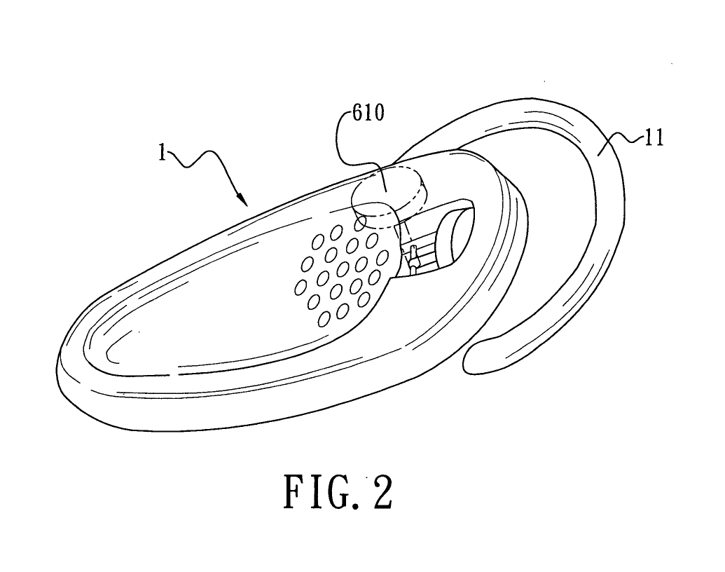

Referring to FIG. 1 and FIG. 2, which are a perspective outward-appearance diagram of the present invention, and a schematic diagram of a speaker in accordance with another preferred embodiment. The present invention comprises an earphone type main body 1. A hook 11 is mounted on an upper end of the earphone type main body 1 for hooking an ear of a user by rotation away from the earphone type main body 1. A retractable microphone 201 is mounted on the outside of the main body 1 for receiving audio signal from outside world to provide with functions of sound-recording or communication with an wireless phone. A speaker 61 is mounted on the inside of the main body 1 for sound production. The speaker 61 can be in the form of fixing type (as shown in FIG. 1), which is fixed directly on the inside of the earphone type main body 1, or ear plug type 610 (as shown in FIG. 2). The ear plug type speaker 610 is connected to the main body 1 through a pivotal shaft such that the speaker can be rotated at 90 degrees perpendicular to the main body 1 so as to plug the ear directly.

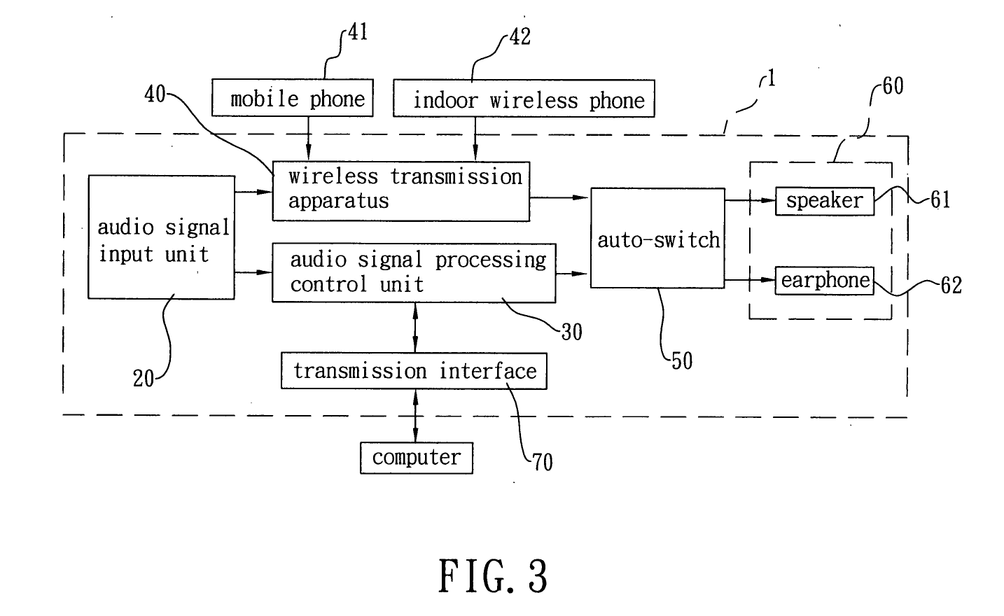

Referring to FIG. 3, the earphone type main body 1 comprises the following:

An audio signal input unit 20, which is, for example, the microphone 201 for sound input, a FM receiver, or a connection with a computer or other electronic equipment by a connection line for music files input.

An audio signal processing control unit 30 for receiving the signal of sound or music inputted by the audio signal input unit 20 to perform the processing and to broadcast through a sound output unit 60.

A wireless transmission apparatus 40, which is used for signal transmission between the main body and the wireless phone to take the incoming phone call. The wireless phone includes a mobile phone 41 or an indoor wireless phone 42.

An auto-switch 50, which is connected to the audio signal processing unit 30 and the wireless transmission apparatus 40 for automatically controlling the broadcasting of the music or the wireless telecommunication signal transmitted from the wireless transmission apparatus 40.

A sound output unit 60, which is connected to the auto-switch 50 to broadcast the MP3 music or take the incoming phone call. The sound output unit 60 is an embedded speaker 61 or an earphone 62.

A transmission interface 70, which is a USB adapter, for connection with an apparatus such as computer to transmit data.

In the manner described above, the hook 11 of the earphone type main body 1 can be worn directly on the ear to listen to the music without carrying an additional music broadcaster. When a phone call is incoming, the wireless transmission apparatus 40 can be used to receive the wireless telecommunication signal, the auto-switch 50 is used to automatically switch the signal transmitted from the audio signal processing control unit 30 from the music signal to the telecommunication signal, which is then outputted through the speaker 61 or the earphone 62 for taking the phone call. When the communication is terminated, it is automatically switched to the music signal for continuously listening to the music.

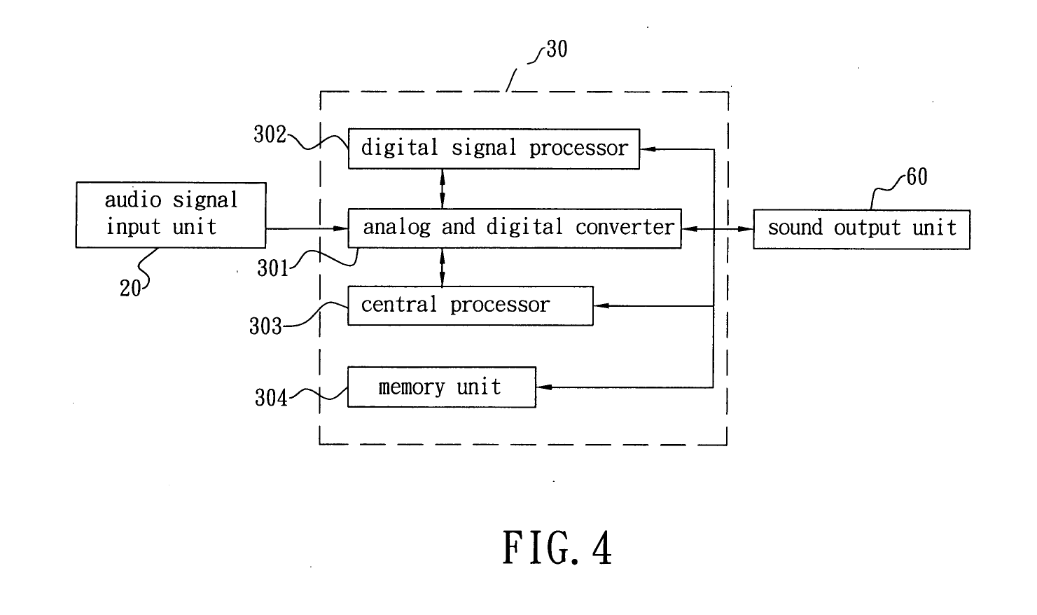

Referring to FIG. 4, a block diagram of the audio signal processing control unit of the present invention is shown. The audio signal processing control unit 30 comprises an analog and digital converter 301 for performing the analog and digital conversion of the inputted sound signal and the outputted sound signal; a digital signal processor (DSP) 302 for performing the digitizing processing of the signal data; a central processor 303 for processing the signal data; and a memory unit 304 for data storage. The audio signal processing control unit 30 is used for processing the voice inputted from the audio signal input unit 20 to perform the sound-recording step; or used for processing the inputted MP3 music which is then broadcasted through the sound output unit 60.

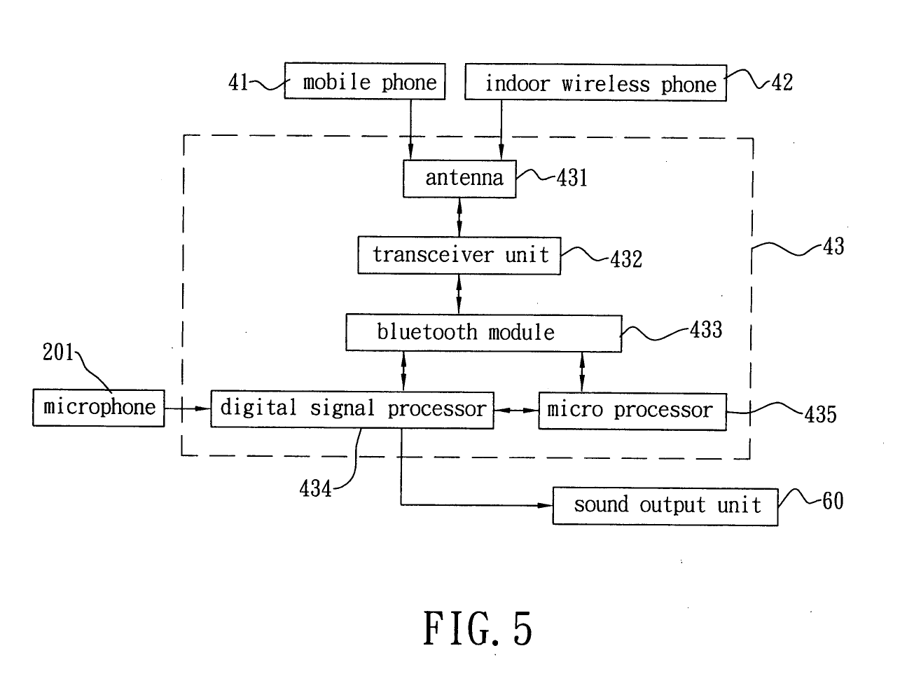

Referring to FIG. 5, a schematic block diagram of the bluetooth communication apparatus of the present invention is disclosed. The wireless transmission apparatus 40 is a bluetooth communication apparatus 43, which comprises an antenna 431 for receiving the wireless signal; a transceiver unit 432 for transforming the wireless signal to provide thereof for the bluetooth module; a bluetooth module 433; a digital signal processor 434; and a micro processor 435 for performing the encoding/decoding step and the signal data processing step, and taking the incoming phone call through the sound output unit 60. When the communication is established, the microphone 201 can be utilized to input the sound such that the signal can be transmitted between the bluetooth apparatus 43 and a bluetooth apparatus of the mobile phone 41 or the indoor wireless phone 42.

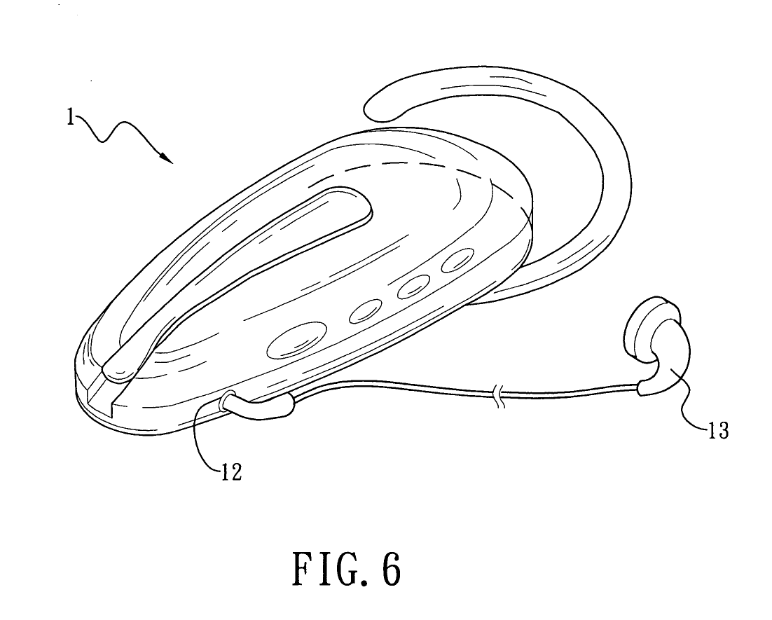

Referring to FIG. 6, the earphone type main body 1 of the present invention can be hung directly on the ear while listening to the music. The main body 1 further comprises an earphone socket 12 to which an ear plug 13 is connected for connecting with the other ear thereby enabling the other ear to listen to the music.

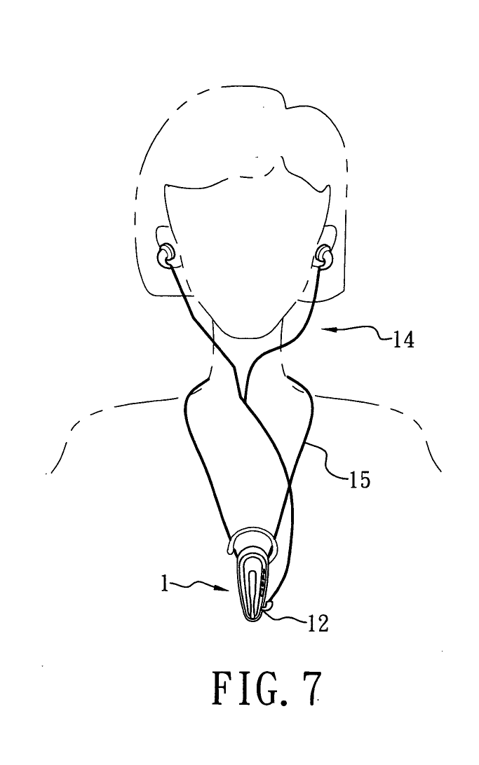

Referring to FIG. 7, which is a schematic diagram showing another usage status of the present invention. A hanging belt 15 may be mounted on the main body 1 of the present invention such that the main body 1 can be carried in front of the chest by hanging on the neck, and a pair of external earphones 14 is inserted into the earphone socket 12 for listening to the music.

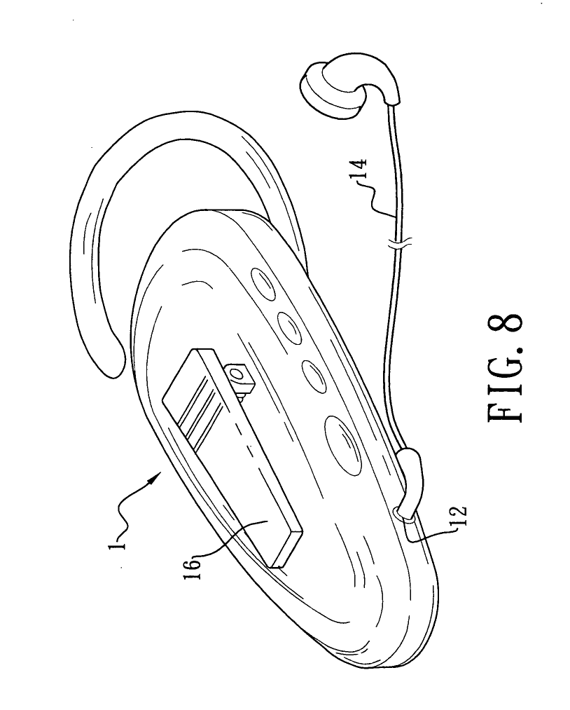

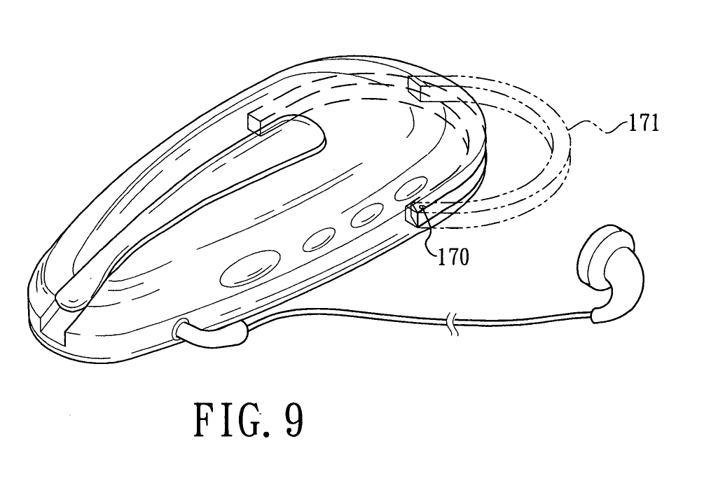

Referring to FIG. 8, which shows another preferred embodiment of the present invention. A clip 16 is mounted on the main body 1, thus the main body 1 can be clipped on the pocket while another earphone 14 is inserted into the earphone socket 12 for listening to the music.

Referring to FIG. 9, which shows a hook of another preferred embodiment of the present invention. A hook 171 is connected pivotally to the upper portion of the main body 1 through a pivotal shaft 170. By rotation around the pivotal shaft 170, the hook 171 can be unfolded against the main body 1 for hanging the main body 1 on the ear.

Therefore, as is understood by a person skilled in the art, the present invention achieves the aforementioned purpose according to the above description and satisfies requirements of patent law. The application for a patent is therefore submitted.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What the invention claimed is:

1. An earphone type music broadcaster comprising:
an earphone type main body comprising:
an audio signal input unit for inputting the sound and music;
an audio signal processing control unit for connection with the audio signal input unit to process voice and music signal data;
a wireless transmission apparatus used for signal transmission between the main body and the wireless phone to take the incoming phone call;
an auto-switch connected to the audio signal processing unit and the wireless transmission apparatus for automatically switching to the broadcasting of the music or the wireless telecommunication signal; and
a sound output unit connected to the auto-switch to broadcast the music or the telecommunication signal.

2. The earphone type music broadcaster of claim 1, wherein the wireless transmission apparatus is a bluetooth communication apparatus which comprises an antenna for receiving a wireless signal; a transceiver unit for transforming the wireless signal to provide thereof for the bluetooth module; a bluetooth module; a digital signal processor; and a micro processor for performing the encoding/decoding step and the signal data processing step

3. The earphone type music broadcaster of claim 1, wherein the audio signal processing control unit comprises an analog and digital converter; a digital signal processor; a central processor; and a memory unit.

4. The earphone type music broadcaster of claim 1, wherein a hook is mounted on the earphone type main body for hanging on an ear.

5. The earphone type music broadcaster of claim 1, wherein the audio signal input unit is a microphone or a FM receiver.

6. The earphone type music broadcaster of claim 5, wherein the microphone is retractable.

7. The earphone type music broadcaster of claim 1, wherein the sound output unit is a speaker and an earphone.

8. The earphone type music broadcaster of claim 7, wherein the speaker is of ear plug type, which is pivotally connected to an inside of the main body through a pivotal shaft to plug an ear by rotating away from the main body.

9. The earphone type music broadcaster of claim 1 wherein the earphone type main body further comprises a USB transmission interface to connect to a computer for data transmission.

10. The earphone type music broadcaster of claim 1 wherein a clip is mounted on the earphone type main body.
